(19) United States
(12) Patent Application Publication
(10) Pub. No.: US 2025/0374030 A1
(43) Pub. Date: Dec. 4, 2025

(54) METHOD AND APPARATUS FOR MANAGING DATA CHANNEL COMMUNICATION

(71) Applicant: Samsung Electronics Co., Ltd., Suwon-si (KR)

(72) Inventors: Madhusudan Gorur MANJUNATH, Bangalore (IN); Priti SINGH, Bangalore (IN); Sunil Kumar NAGARAJU, Bangalore (IN); Kaja Mohaideen MOHAMED ALI, Bangalore (IN)

(21) Appl. No.: 19/220,921

(22) Filed: May 28, 2025

Related U.S. Application Data
(63) Continuation of application No. PCT/KR2025/007179, filed on May 27, 2025.

(30) Foreign Application Priority Data
May 28, 2024 (IN) 202441041481
May 13, 2025 (IN) 2024 41041481

(51) Int. Cl. H04W 8/20; H04W 8/18; H04W 48/18

(52) U.S. Cl. CPC H04W 8/20; H04W 8/183; H04W 48/18

(57) ABSTRACT

A method for managing data channel communication by a user equipment (UE) is provided. The method includes determining transmit a root application request, transmitting the root application request comprising a first application type information element (IE) associated with the root application, based on determining to transmit the root application request, and receiving a root application response based on the first application type IE associated with the root application, in response to the root application request, wherein the root application response comprise at least one of a list of data channel applications, a root application version IE and a root application validity IE.

### CROSS-REFERENCE TO RELATED APPLICATION(S)

This application is a continuation application, claiming priority under 35 U.S.C. § 365(c), of an International application No. PCT/KR2025/007179, filed on May 27, 2025, which is based on and claims the benefit of an Indian Provisional patent application number 202441041481, filed on May 28, 2024, in the Indian Intellectual Property Office, and of an Indian Complete patent application No. 202441041481, filed on May 13, 2025, in the Indian Intellectual Property Office, the disclosure of each of which is incorporated by reference herein in its entirety.

### FIELD OF THE INVENTION

The disclosure relates to telecommunication. More particularly, the disclosure relates to apparatuses and methods for managing data channel communication.

### BACKGROUND

Data channel communication technology has emerged as a critical component in modern telecommunication systems, enabling the exchange of multimedia content and applications between user equipment. In particular, Internet Protocol Multimedia Subsystem (IMS) Data Channel (IDC) communication facilitates interactive services between users during ongoing voice sessions. Data channel communication has gained significance with the deployment of advanced mobile networks, particularly in fifth generation (5G) communication systems where enhanced multimedia interaction capabilities are required.

In conventional data channel communication systems, applications are delivered to a user equipment (UE) through a process known as bootstrapping. A bootstrap procedure establishes an IDC and renders applications from a Data Channel (DC) Server. When a user selects an application, the application is downloaded through a bootstrap session.

A user initiates the DC communication by making a call. Once the call connects, as part of the bootstrap procedure, the UE downloads a root application from an enhanced Multimedia Telephony (eMMTel) service provider. The root application from the eMMTel service provider mainly contains application profiles (i.e., information about applications such as name, description, version, etc.), DC application thumbnails and layout. When a user selects an application thumbnail, the UE downloads the respective application through the DC.

FIG. 1A illustrates a signal flow diagram depicting a method for managing data channel communication between the UE and the DC server, according to the related art.

The signal flow 100-A involves a communication between the UE 102 comprising an eMMTel client 104, and an eMMTel Enabler Server 108 over a Domain Centralized Services Function (DCSF) 106. At operation 110, the eMMTel Client 104 transmits a get root application request to the eMMTel Enabler Server 108 via the DCSF 106. At operation 112, the eMMTel Enabler Server 108 compares whether a root application stored in the eMMTel Client 104 is the newest version. At operation 114, the eMMTel Enabler Server 108 transmits a get root application response to the eMMTel Client 104 via the DCSF 106. At operation 116, the eMMTel Client 104 transmits a get data channel application profile list request to the eMMTel Enabler Server 108 via the DCSF 106. At operation 118, the eMMTel Enabler Server 108 transmits a get data channel application profile list response to the eMMTel Client 104 via the DCSF 106.

FIG. 1B illustrates a signal flow diagram depicting the method for managing data channel communication between two users, according to the related art.

The signal flow 100-B involves a first UE 120 and a second UE 122. At operation 124, the first UE 120 transmits a Session Initiation Protocol (SIP) Invite message to the second UE 122 to initiate a call. At operation 126, the second UE 122 responds with a 200 OK message, indicating acceptance of the call. At operation 127, the first UE 120 sends a Hypertext Transfer Protocol (HTTP) GET: Main Menu (MM) request to retrieve the main menu. At operation 128, the second UE 122 responds with a 200 OK (main menu Hypertext Markup Language (HTML)) message, delivering the main menu interface. At operation 130, the first UE 120 sends an HTTP GET: Application (APP) request to download a specific application. At operation 132, the second UE 122 responds with a 200 OK message, delivering the requested application. At operation 134, the first UE 120 sends a BYE message to terminate the call. At operation 136, the second UE 122 responds with a 200 OK message, acknowledging the call termination.

Subsequently, at operation 138, the first UE 120 transmits another SIP Invite message to the second UE 122 to initiate a new call. At operation 140, the second UE 122 responds with a 200 OK message. At operation 142, the first UE 120 sends an HTTP GET: MM request to retrieve the main menu again. At operation 144, the second UE 122 responds with a 200 OK (main menu HTML) message. At operation 146, the first UE 120 selects an application and sends an HTTP GET: APP request. At operation 148, the second UE 122 responds with a 200 OK message, delivering the requested application.

The conventional approach for managing data channel communications faces several limitations. A significant limitation involves the repetitive execution of the bootstrap procedure for every call establishment, even when there are no changes in the application list provided by the DC Server. The bootstrap procedure is performed for every call even though there is no change in the list of applications from the DC Server, which leads to performance issues and unnecessary usage of background data.

Further, the conventional method leads to repetitive downloading of the root application during each call establishment. The root application is downloaded every time whenever a call is established, leading to unnecessary resource utilization and delay in the loading of an interface screen.

For a single IDC application, the root application size is approximately 100 kilobytes (KB), with a selected application size of approximately 100 megabytes (MB), resulting in a total size of approximately 101.1 MB. For 10 IDC applications, while the root application size remains approximately 100 KB, the 10 selected applications require approximately 1000.1 MB of total download size. As an application is downloaded whenever a user selects the application, this approach significantly increases the total download volume.

Furthermore, some of the applications are not significant when dialed to specific numbers. For example, when a user makes an emergency call, displaying gaming applications, Interactive Voice Response (IVR) related applications, or other non-essential applications to the user is not required. Instead, only emergency-related applications such as SOS, medical emergency, fire, and police should be offered to the user. The application list is not retrieved based on contact information, call type, or application type (emergency, conference, Extended Reality (XR), etc.). In conventional methods, the same application list is received from the DC server irrespective of application type. When a user makes an emergency call or IVR call, related applications such as health records (Blood Pressure, Heartbeat check), nearest hospital, and an ambulance should be received from the DC server for a better user experience. The conventional method causes an increase in the data usage for the user as irrelevant applications are shown to the user without considering the context of the call and the type of the application.

In emergency situations, the time required to access relevant applications becomes critical. However, the bootstrap procedure in the conventional method delays application access due to redundant downloads and displaying irrelevant applications. This delay impacts both resource utilization and user experience during time-sensitive situations.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide a system and method for managing data channel communication.

Additional aspects will be set forth in part in the description which follows and, in part, will be apparent from the description, or may be learned by practice of the presented embodiments.

In accordance with an aspect of the disclosure, a method for managing data channel communication by a user equipment (UE) is provided. The method includes determining to transmit a root application request, transmitting the root application request comprising a first application type information element (IE) associated with the root application, based on determining to transmit the root application request, receiving a root application response based on the first application type IE associated with the root application, in response to the root application request, wherein the root application response comprises a list of data channel applications, a root application version IE, and a root application validity IE.

In accordance with an aspect of the disclosure, a method for managing data channel communication by a server is provided. The method includes receiving a root application request comprising a first application type information element (IE) with the root application stored in a user equipment (UE), determining a list of one or more data channel applications based the first application type IE associated with the root application stored in the UE, and transmitting a root application response comprising a root application validity IE and a root application version IE, and the determined list of one or more data channel applications.

In accordance with an aspect of the disclosure, a user equipment (UE) for managing data channel communication is provided. The UE includes memory, comprising one or more storage media, storing instructions, and at least one processor communicatively coupled to the memory, wherein the instructions, when executed by the at least one processor individually or collectively, cause the UE to determine to transmit a root application request, transmit the root application request comprising a first application type information element (IE) associated with the root application, in response to determining to transmit the root application request, and receive a root application response based on the first application type IE associated with the root application, in response to the root application request, wherein the root application response comprises a list of data channel applications, a root application version IE, and a root application validity IE.

In accordance with an aspect of the disclosure, a system for managing data channel communication by a server is provided. The system includes memory, comprising one or more storage media, storing instructions, and at least one processor communicatively coupled to the memory, wherein the instructions, when executed by the at least one processor individually or collectively, cause the system to receive a root application request containing one or more of a first application type information element (IE), and a root application version IE associated with the root application stored in a user equipment (UE), determine a list of one or more data channel applications based on one or more of the first application type IE, and the root application version IE associated with the root application stored in the UE, and transmit a root application response comprising one or more of a root application validity IE and the root application version IE, and the determined list of one or more data channel applications.

In accordance with an aspect of the disclosure, one or more non-transitory computer-readable storage media storing one or more computer programs including computer-executable instructions that, when executed by one or more processors of an electronic device individually or collectively, cause the electronic device to perform operations are provided. The operations include determining by the UE, a need to transmit a root application request, transmitting by the UE, the root application request containing a first application type information element (IE) associated with the root application, in response to determining that there is a need to transmit the root application request, and in response to the root application request being transmitted, receiving, by the UE, a root application response based on the first application type IE associated with the root application, wherein the root application response include a list of data channel applications, a root application version IE, and a root application validity IE.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1A illustrates a signal flow diagram depicting a method for managing data channel (DC) communication between a User Equipment (UE) and a server, according to the related art;

FIG. 1B illustrates a signal flow diagram depicting the method for managing DC communication between two users, according to the related art;

FIG. 2 is a schematic diagram illustrating an environment for implementation of a system and the method for managing DC communication, according to an embodiment of the disclosure;

FIG. 3 illustrates a block diagram depicting an architecture for managing DC communication, according to an embodiment of the disclosure;

FIG. 4 is a block diagram illustrating the system for managing DC communication, according to an embodiment of the disclosure;

FIG. 5 illustrates a process flow associated with a transmission need determination module of the system, according to an embodiment of the disclosure;

FIG. 6 illustrates a process flow associated with a DC application list determination module of the system, according to an embodiment of the disclosure;

FIG. 7 illustrates a signal flow diagram depicting the method for managing DC communication between the UE and the server, according to an embodiment of the disclosure;

FIGS. 8A, 8B, and 8C illustrate various use cases of the system and the method for managing DC communication, according to various embodiments of the disclosure;

FIG. 9 illustrates a flow chart depicting the method for managing DC communication, according to an embodiment of the disclosure; and

FIG. 10 illustrates a flow chart depicting the method for managing DC communication, according to another embodiment of the disclosure.

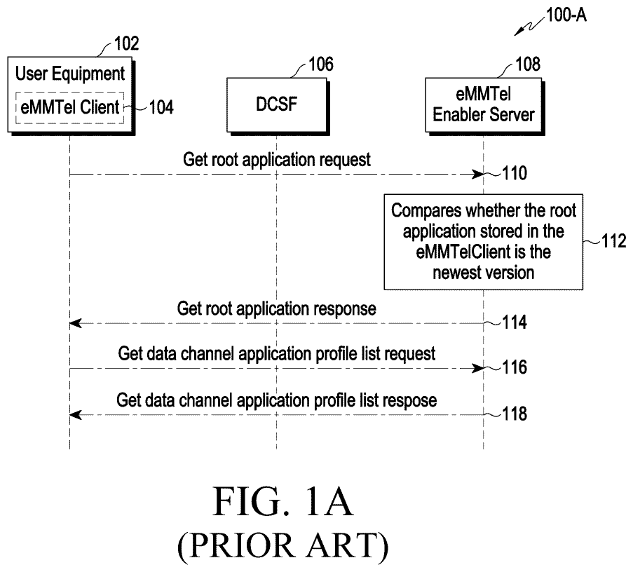

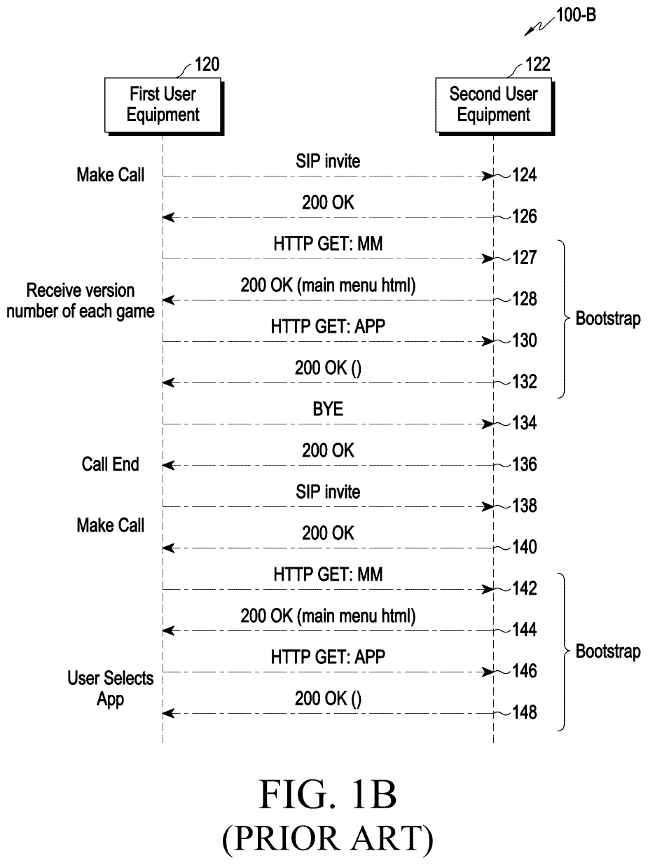

Throughout the drawings, like reference numerals will be understood to refer to like parts, components, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

It will be understood by those skilled in the art that the foregoing general description and the following detailed description are explanatory of the disclosure and are not intended to be restrictive thereof.

Reference throughout this specification to “an aspect,” “another aspect” or similar language means that a particular feature, structure, or characteristic described in connection with the embodiment is included in at least one embodiment of the disclosure. Thus, appearances of the phrase “in an embodiment,” “in another embodiment” and similar language throughout this specification may, but do not necessarily, all refer to the same embodiment.

The terms “comprises”, “comprising”, or any other variations thereof, are intended to cover a non-exclusive inclusion, such that a process or method that comprises a list of steps does not include only those steps but may include other steps not expressly listed or inherent to such process or method. Similarly, one or more devices or sub-systems or elements or structures or components proceeded by “comprises . . . a” does not, without more constraints, preclude the existence of other devices or other sub-systems or other elements or other structures or other components or additional devices or additional sub-systems or additional elements or additional structures or additional components.

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. Also, the various embodiments described herein are not necessarily mutually exclusive, as some embodiments can be combined with one or more other embodiments to form new embodiments. The term “or” as used herein, refers to a non-exclusive or unless otherwise indicated. The examples used herein are intended merely to facilitate an understanding of ways in which the embodiments herein can be practiced and to further enable those skilled in the art to practice the embodiments herein. Accordingly, the examples should not be construed as limiting the scope of the embodiments herein.

Embodiments may be described and illustrated in terms of blocks that carry out a described function or functions. These blocks, which may be referred to herein as units or modules or the like, are physically implemented by analog or digital circuits such as logic gates, integrated circuits, microprocessors, microcontrollers, memory circuits, passive electronic components, active electronic components, optical components, hardwired circuits, or the like, and may optionally be driven by firmware and software. Each block of the embodiments may be physically separated into two or more interacting and discrete blocks without departing from the scope of the disclosure. Likewise, the blocks of the embodiments may be physically combined into more complex blocks without departing from the scope of the disclosure.

The accompanying drawings are used to help easily understand various technical features and it should be understood that the embodiments presented herein are not limited by the accompanying drawings. As such, the disclosure should be construed to extend to any alterations, equivalents, and substitutes in addition to those which are particularly set out in the accompanying drawings. Although the terms first, second, etc. may be used herein to describe various elements, these elements should not be limited by these terms. These terms are generally only used to distinguish one element from another.

Described herein is a technique for managing data channel (DC) communication. According to the technique disclosed herein, a user equipment (UE) determines a need to transmit a root application request and transmits the root application request containing a first application type information element (IE) associated with the root application. In response to the root application request being transmitted, the UE receives a root application response based on the first application type IE. The root application response comprises a list of data channel applications, a root application version IE, and a root application validity IE. The UE may further transmit a data channel application profile list request including a second application type IE and receive an application profile list response containing a list of one or more data channel applications with associated version and validity information. Thus, the disclosure provides efficient DC communication by verifying the validity and the version of locally stored applications before downloading, thereby reducing unnecessary data usage, minimizing bootstrap procedure repetition, and delivering context-relevant applications to users.

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a wireless fidelity (Wi-Fi) chip, a Bluetooth® chip, a global positioning system (GPS) chip, a near field communication (NFC) chip, connectivity chips, a sensor controller, a touch controller, a finger-print sensor controller, a display driver integrated circuit (IC), an audio CODEC chip, a universal serial bus (USB) controller, a camera controller, an image processing IC, a microprocessor unit (MPU), a system on chip (SoC), an IC, or the like.

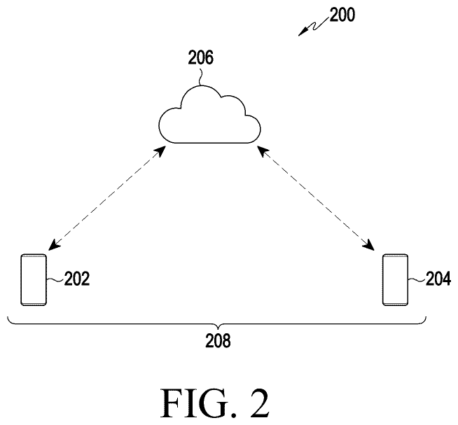

FIG. 2 is a schematic diagram illustrating an environment 200 for the implementation of a system and a method for managing DC communication, according to an embodiment of the disclosure.

The environment 200 may include a first UE 202, a second UE 204 connected over a server 206. The first UE 202 and the second UE 204 may communicate with each other through the server 206. The first UE 202 and the second UE 204 may be connected to the server 206 through a communication network. The communication network may include, but may not be limited to, a fifth-generation (5G) network, a fourth-generation (4G) network, or any other suitable communication network.

In an embodiment, the UE 202, 204 may be a mobile phone, a multimedia device, a tablet, a laptop, or any other suitable electronic device capable of establishing communication with another UE through the communication network. The server 206 may be an enhanced Multimedia Telephony (eMMTel) server configured to facilitate DC communication between the first UE 202 and the second UE 204. The eMMTel server 206 in coordination with the UE 202, 204 may be configured to manage various aspects of DC communication, including establishment of Internet protocol Multimedia Subsystem (IMS) Data Channel (IDC), management of DC applications, and coordination of bootstrap procedures.

The first UE 202 may initiate a communication session with the second UE 204. The communication session may include voice communication, video communication, or any other suitable form of real-time communication. During the communication session, the first UE 202 and the second UE 204 may exchange data through data channels established by the eMMTel server 206. The DC communication may enable enhanced interactive features beyond traditional voice or video calling. The data channels, for example, may facilitate sharing of applications, games, multimedia content, documents, or any other suitable data between the first UE 202 and the second UE 204 during the communication session.

The eMMTel server 206 may maintain a repository of data channel applications. The data channel applications may include interactive games, content sharing tools, collaborative work applications, or any other suitable applications designed to enhance the communication experience between the first UE 202 and the second UE 204.

A bootstrap procedure may be conducted at the beginning of each communication session between the first UE 202 and the second UE 204. In another embodiment, the bootstrap procedure may establish the IDC between the first UE 202 and the server 206 and between the second UE 204 and the server 206, and may render applications from the eMMTel server 206 to the first UE 202 and the second UE 204. During the bootstrap procedure, the eMMTel server 206 may transmit a list of available data channel applications to the first UE 202 and the second UE 204. A user of the first UE 202 or the second UE 204 may select one or more applications from the list. The selected applications may be downloaded to the respective UE through the bootstrap session during the communication session.

Although the disclosure describes the method for managing the DC communication in reference to interactive calling, the method for managing the DC communication may not be limited to interactive calling scenarios. The method for managing the DC communication may be applicable to any communication scenario involving data channel establishment, including but not limited to, multimedia sharing, collaborative applications, remote assistance, augmented reality interactions, virtual reality interactions, or any other suitable communication scenario involving data channel utilization.

Although the communication session is described between the first UE 202 and the second UE 204, the communication session may not be limited to two UEs and may include any number of UEs connected through the server 206. For the simplicity of understanding, the disclosure is described in reference to communication between the server 206 and one UE. The same method and system may be implemented between any number of UE and the server 206. Hereinafter, the first UE 202, the second UE 204, and any other UE involved in the communication session are singularly referred to as the UE 208.

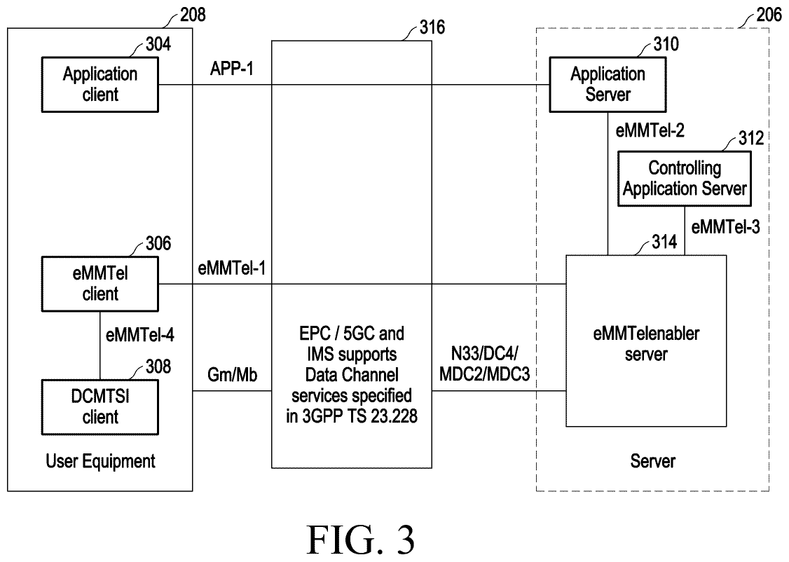

FIG. 3 illustrates a block diagram depicting an architecture 300 for managing DC communication, according to an embodiment of the disclosure.

The data channel communication may include the UE 208, an application server 310, a controlling application server 312, an eMMTel enabler server 314, and an Evolved Packet Core (EPC)/5G Core (5GC) and IMS 316. The UE 208 may include an application client 304, an eMMTel client 306, and a Data Channel Mobile Terminating Session Initiation (DCMTSI) client 308.

The application client 304 may be configured to handle application-specific functionalities and may communicate with the application server 310 through an application (APP)-1 interface. The application client 304 may be responsible for rendering user interfaces, handling user inputs, and displaying application content to a user.

The eMMTel client 306, for example, may be a software component residing on the UE 208. The eMMTel client 306 may be configured to handle enhanced Multimedia Telephony (eMMTel) functionalities. The eMMTel client 306 may communicate with the eMMTel enabler server 314 through an eMMTel-1 interface. The eMMTel client 306 may manage the establishment, maintenance, and termination of multimedia sessions.

The DCMTSI client 308 may be configured to handle DCMTSI functionalities. The DCMTSI client 308 may communicate with the EPC/5GC and IMS 316 through a Gm/Mb interface. The DCMTSI client 308 may be responsible for establishing and managing data channels during communication sessions.

The eMMTel client 306 and the DCMTSI client 308 may communicate through an eMMTel-4 interface. This interface may facilitate coordination between eMMTel functionalities and data channel management functionalities within the UE 208.

The application server 310 may be configured to host application-specific functionalities. The application server 310 may communicate with the application client 304 through an APP-1 interface and with the controlling application server 312 through an eMMTel-2 interface. The application server 310 may store and manage application data, process application requests, and deliver application responses.

In an embodiment, the controlling application server 312 may be configured to control and coordinate application functionalities across the architecture 300. The controlling application server 312 may communicate with the application server 310 through an eMMTel-2 interface and with the eMMTel enabler server 314 through an eMMTel-3 interface. The controlling application server 312 may enforce application policies, manage application priorities, and coordinate multi-application scenarios.

The eMMTel enabler server 314 may be configured to enable and facilitate eMMTel functionalities across the DC communication. The eMMTel enabler server 314 may communicate with the eMMTel client 306 through an eMMTel-1 interface, with the controlling application server 312 through an eMMTel-3 interface, and with the EPC/5GC and IMS 316 through a Network Interface 33 (N33)/Data Channel Interface 4 (DC4)/Multimedia Data Channel Interface 2 (MDC2)/Multimedia Data Channel Interface 3 (MDC3) interface. The eMMTel enabler server 314 may manage multimedia session parameters, coordinate media streams, and ensure quality of service for multimedia sessions.

The EPC/5GC and IMS 316 may, for example, support data channel services specified in 3rd Generation Partnership Project Technical Specification (3GPP TS) 23.228. The EPC/5GC and IMS 316 may communicate with the DCMTSI client 308 through a Gm/Mb interface and with the eMMTel enabler server 314 through the N33/DC4/MDC2/MDC3 interface. The EPC/5GC and IMS 316 may provide network-level support for data channel services, manage network resources, and ensure proper routing of data channel traffic.

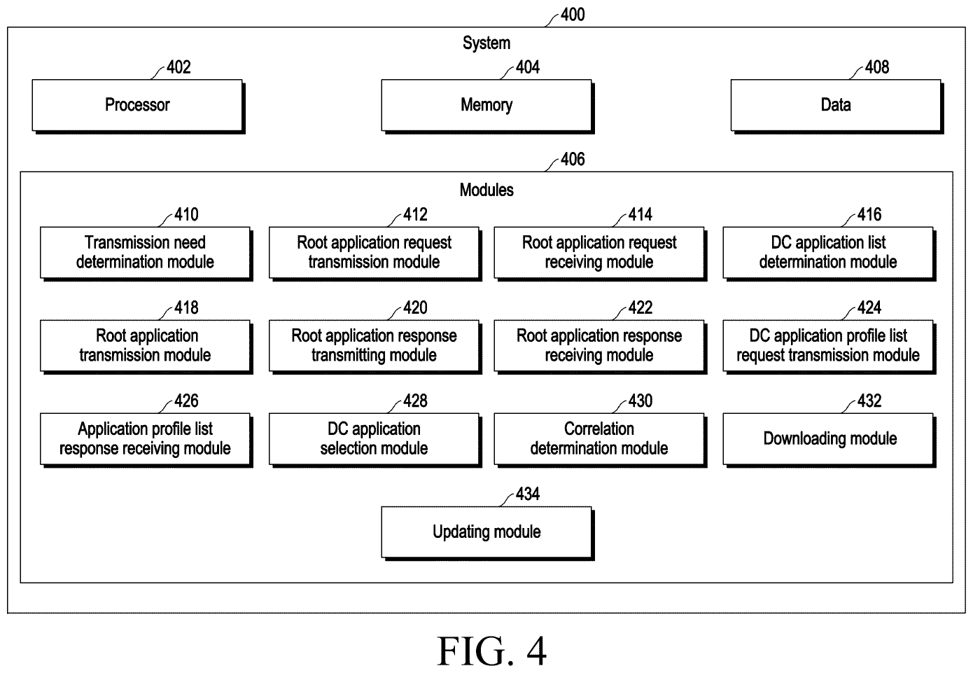

The system for managing DC communication may be implemented as a distributed system. The distributed system may include components distributed across the UE and a server. Detailed operational and functional details of the system may be described in reference to FIGS. 4 to 7, 8A to 8C, 9, and 10.

FIG. 4 is a block diagram illustrating the system for managing DC communication, according to an embodiment of the disclosure.

The system 400 may include but is not limited to, a processor 402, memory 404, modules 406, and data 408. The modules 406 and the memory 404 may be coupled to the processor 402.

The processor 402 may be a single processing unit or several units, all of which could include multiple computing units. The processor 402 may also be implemented as one or more microprocessors, microcomputers, microcontrollers, digital signal processors, central processing units, state machines, logic circuitries, and/or any devices that manipulate signals based on operational instructions. Among other capabilities, the processor 402 may be adapted to fetch and execute computer-readable instructions and data stored in the memory 404.

The memory 404 may include any non-transitory computer-readable medium known in the art including, for example, volatile memory, such as static random-access memory (SRAM) and dynamic random-access memory (DRAM), and/or non-volatile memory, such as read-only memory (ROM), erasable programmable ROM, flash memories, hard disks, optical disks, and magnetic tapes. The memory 404 may alternatively be referred to as a database in the disclosure, within the scope of the disclosure.

The modules 406, amongst other things, include routines, programs, objects, components, data structures, etc., which perform particular tasks or implement data types. The modules 406 may also be implemented as, signal processor(s), state machine(s), logic circuitries, and/or any other device or component that manipulates signals based on operational instructions.

The modules 406 may be implemented in hardware, instructions executed by a processing unit, or by a combination thereof. The processor 402 can comprise a computer, a processor, a state machine, a logic array, or any other suitable devices capable of processing instructions. The processing unit can be a general-purpose processor (e.g., processor 402) which executes instructions to cause the general-purpose processor to perform the required tasks, or, the processing unit can be dedicated to performing the required functions. In another embodiment of the disclosure, the modules 406 may be machine-readable instructions (software) which, when executed by the processor 402/processing unit, perform any of the described functionalities/methods, as discussed throughout the disclosure.

The processor 402 may include one or a plurality of processors. At this time, one or a plurality of processors may be a general purpose processor, such as a central processing unit (CPU), an application processor (AP), or the like, a graphics-only processing unit such as a graphics processing unit (GPU), a visual processing unit (VPU), and/or an AI-dedicated processor such as a neural processing unit (NPU).

The one or the plurality of processors control the processing of the input data in accordance with a predefined operating rule or artificial intelligence (AI) model stored in the non-volatile memory and the volatile memory. The predefined operating rule or artificial intelligence model is provided through training or learning.

In another embodiment, the modules 406 may include a transmission need determination module 410, a root application request transmission module 412, a root application request receiving module 414, a DC application list determination module 416, a root application transmission module 418, a root application response transmitting module 420, a root application response receiving module 422, a DC application profile list request transmission module 424, an application profile list response receiving module 426, a DC application selection module 428, a correlation determination module 430, a downloading module 432, and an updating module 434. The transmission need determination module 410, the root application request transmission module 412, the root application request receiving module 414, the DC application list determination module 416, the root application transmission module 418, the root application response transmitting module 420, the root application response receiving module 422, the DC application profile list request transmission module 424, the application profile list response receiving module 426, the DC application selection module 428, the correlation determination module 430, the downloading module 432, and the updating module 434 may be in communication with each other. The data 408 serves, amongst other things, as a repository for storing data processed, received, and generated by one or more of the modules 406.

The transmission need determination module 410, the root application request transmission module 412, the root application response receiving module 422, the DC application profile list request transmission module 424, the application profile list response receiving module 426, the DC application selection module 428, the correlation determination module 430, the downloading module 432, and the updating module 434 may be implemented at the UE 208. Further, the root application request receiving module 414, the DC application list determination module 416, the root application transmission module 418, the root application response transmitting module 420 may be implemented at the eMMTel enabler server 314 (interchangeably referred to as a server 206).

In another embodiment, the transmission need determination module 410 may be configured to determine a need to transmit a root application request. The need to transmit the root application request may be determined by the UE 208. The root application request may indicate a request for obtaining information regarding available data channel applications.

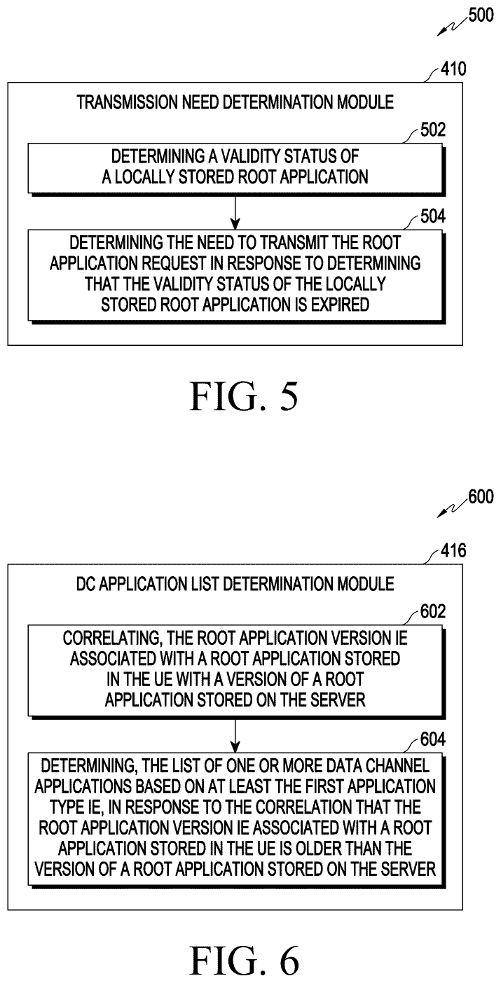

FIG. 5 illustrates a process flow 500 associated with the transmission need determination module 410 of the system 400, according to an embodiment of the disclosure.

The process flow 500, at operation 502, includes determining a validity status of a locally stored root application. The validity status may indicate whether the locally stored root application is valid for use in the current communication session. The validity status may be determined based on a root application validity IE associated with the locally stored root application. The locally stored root application may refer to a root application that has been previously downloaded and stored in the memory of the UE 208 during a previous communication session. The root application may serve as a container or manager for data channel applications, coordinating their operation during a communication session. The validity status may indicate an expiration date or time period during which the root application may be considered valid.

The process flow 500, at operation 504, includes determining the need to transmit the root application request in response to determining that the validity status of the locally stored root application is expired. When the validity status is found to be expired, the transmission need determination module 410 may determine that a new root application needs to be downloaded from the server.

Referring again to FIG. 4, the root application request transmission module 412 may be configured to transmit the root application request containing a first application type IE associated with the root application. The root application request transmission module 412 may transmit the root application request in response to determining that there is a need to transmit the root application request. The root application request may be transmitted by the UE 208. The root application request may be transmitted to the server.

The root application request may indicate a request for obtaining the root application from the server 206. The root application request may, for example, include various information elements that may help the server identify the appropriate root application to be provided to the UE 208. The root application may act as a container for DC applications during a communication session.

The first application type IE may indicate the type of application being requested. The application type may include, but may not be limited to, emergency applications, conference applications, extended reality (XR) applications, gaming applications, or any other suitable type of application. The application type IE may help the server determine the specific features and capabilities required in the root application.

Table 1 illustrates a list of the IEs contained in the root application request.

TABLE 1

| Information | | |
|---|---|---|
| element | Status | Description |
| UE Information | M | The UE related information required to identify |
| (see NOTE) | | the Root application (e.g. device type, device |
| | | vendor, etc) |
| Root | O | The newest version of the Root application |
| application | | stored in the eMMTel Client in the UE. |
| version | | This IE presents if Root application is locally |
| | | stored in the eMMTel Client. |
| application | O | Type of application (e.g. emergency, |
| type | | conference, XR, etc.) |

(NOTE):
The eMMTel service provider can provide the eMMTel Client with different Root application based on this IE.

The UE Information IE may include information required to identify the root application. The UE Information IE may include device type, device vendor, or any other suitable information that may help identify the appropriate root application. The UE Information IE may have a mandatory status in the root application request.

The Root application version IE may include the newest version of the root application stored in the eMMTel Client in the UE. The Root application version IE may be present if the root application is locally stored in the eMMTel Client. The Root application version IE may have an optional status in the root application request.

In an embodiment, the application type IE may indicate the type of application. The application type may include, but may not be limited to, emergency, conference, extended reality (XR), or any other suitable type of application. The application type IE may have an optional status in the root application request.

The server may use the information contained in the root application request to determine the appropriate root application to be provided to the UE 208. The server 206 may consider the UE information, the root application version, and the application type when determining the root application.

In an embodiment, the root application request receiving module 414 may be configured to receive the root application request containing one or more of the first application type IE, and the root application version IE associated with the root application stored in the UE 208. The root application request receiving module 414 may be implemented on the server 206. The root application request may be received by the server 206 from the UE 208. The root application request receiving module 414 may extract the IEs from the received root application request.

The DC application list determination module 416 may be configured to determine a list of one or more data channel applications based on one or more of the first application type IE, and the root application version IE associated with the root application stored in the UE 208. The DC application list determination module 416 may be implemented on the server 206. The DC application list determination module 416 may analyze the IEs received in the root application request to determine the appropriate data channel applications to be included in the response.

FIG. 6 illustrates a process flow 600 associated with the DC application list determination module 416 of the system 400, according to an embodiment of the disclosure.

The process flow 600, at operation 602, involves correlating the root application version IE associated with the root application stored in the UE 208 with a version of the root application stored on the server 206. The correlation may involve comparing the version number of the root application stored in the UE 208 with the version number of the root application stored on the server 206. The correlation may help determine whether the UE 208 has the latest version of the root application. The correlation may also help determine whether the UE 208 needs to update the root application.

The process flow 600, at operation 604, involves determining the list of one or more data channel applications based on at least the first application type IE, in response to the correlation that the root application version IE associated with the root application stored in the UE 208 is older than the version of a root application stored on the server 206. The first application type IE may be used to filter the DC applications based on the type of application requested by the UE 208. The determined list of DC applications may be included in the root application response to be sent to the UE 208.

Referring again to FIG. 4, in an embodiment, the root application transmission module 418 may be configured to transmit the root application. The root application may include the determined list of one or more data channel applications. The root application transmission module 418 may be implemented on the server 206.

The root application transmitted may include various components, including but not limited to, the core root application code, the determined list of data channel applications, root application validity information, and root application version information. The root application may be transmitted to the UE 208. The transmitted root application may replace the older version of the root application stored on the UE 208, if any.

In another embodiment, the root application response transmitting module 420 may be configured to transmit a root application response. The root application response may include one or more of a root application validity IE and the root application version IE, and the determined list of one or more data channel applications. The root application response transmitting module 420 may be implemented on the server 206. The root application response may be transmitted in response to the root application request received from the UE 208.

The root application response may contain various information elements that may help the UE determine whether to update the locally stored root application and provide information about available data channel applications. The root application validity IE may, for example, indicate the period during which the root application may be considered valid. The root application version IE may indicate the current version of the root application available on the server. The determined list of data channel applications may include applications compatible with the root application and matching the application type requested by the UE.

Table 2 illustrates a list of IEs in the root application response.

TABLE 2

| Information | | |
|---|---|---|
| element | Status | Description |
| Result | M | Indicates the success or failure of Get Root |
| | | application request. |
| Update | M | Indicates whether the Root application is |
| needed | | needed to be updated by the eMMTel Client |
| | | in the UE |
| Root | O | The newest version of the Root application. |
| application | | This IE presents only if the Root application |
| version | | is needed to be downloaded or updated by |
| | | the eMMTel Client in the UE. |
| Root | O | The validity of the Root application. This IE |
| application | | presents only if the Root application is |
| validity | | needed to be downloaded or updated by the |
| | | eMMTel Client in the UE. |
| Root | O | The Root application provided by the |
| application | | eMMTel service provider, e.g. layout, and/or |
| (see NOTE) | | home page etc of the Data Channel |
| | | Application list. |
| | | This IE presents if the update of the Root |
| | | application in the UE is needed, i.e. the Root |
| | | application version included in the Get Root |
| | | application request is not equal to the newest |
| | | version on the eMMTel Enabler Server. |

(NOTE):
The detailed information of this IE is implementation specific and out of scope of the present document.

The Root application validity IE may indicate the validity period of the root application. The root application validity IE may have an optional status in the root application response. The root application validity IE may be present only if the root application needs to be downloaded or updated by the eMMTel Client 306 in the UE 208. The Root application validity IE may help the UE 208 determine when to request an updated Root application in the future.

In an embodiment, the root application response receiving module 422 may be configured to receive the root application response. The root application response receiving module 422 may be implemented in the UE 208. The root application response receiving module 422 may extract various IEs from the received root application response. The extracted IEs may include the root application validity IE, the root application version IE, and the list of data channel applications.

In another embodiment, the updating module 434 may be configured to update the locally stored root application based on the root application validity IE and the root application version IE.

If the root application is locally stored in the UE, the validity of the locally stored root application may be updated to the value received in the root application validity IE. The root application version IE and the root application validity IE received in the root application response may be a positive value, 0, or a negative value.

If the root application version IE and the root application validity IE are positive values, the UE 208 may update the version and validity of the locally stored root application accordingly. The positive values may, for example, indicate the normal operation of the root application with a specific validity period.

When the server chooses to block the root application temporarily on the UE 208, the root application version IE and the root application validity IE may be set as 0 in the root application response. When the root application version IE and the root application validity IE are set as 0, the UE 208 may send a root application request when bootstrap data channels are established in the next session. The value 0 may indicate a temporary suspension of the root application.

When the server chooses to block the root application permanently on the UE 208, the root application version IE and the root application validity IE may be set as negative values in the root application response. When the root application version IE and the root application validity IE are set as negative values, the UE 208 may remove the locally stored root application. The negative values may indicate a permanent revocation of the root application.

The root application response receiving module 422 may interpret these values and take appropriate actions based on the received values.

Upon receiving the root application and the root application response, the UE 208 may display a root application interface to the user. The root application interface may present the list of data channel applications to the user. The root application interface may be designed to facilitate easy selection and launching of data channel applications.

The DC application profile list request transmission module 424 may be configured to transmit a DC application profile list request comprising at least a second application type IE. The DC application profile list request transmission module 424 may be implemented on the UE.

The data channel application profile list request may be transmitted after receiving the root application response. The data channel application profile list request may be used to obtain detailed information about specific data channel applications. The second application type IE may indicate the type of data channel applications for which the UE is requesting detailed information.

Table 3 illustrates a list of IEs in the application profile list request.

TABLE 3

| Information | | |
|---|---|---|
| element | Status | Description |
| eMMTel Client | M | The version of eMMTel Client |
| version | | |
| (see NOTE) | | |
| application | O | type of application (e.g. emergency, |
| type | | conference, XR, etc.) |
| Begin index | O | The starting index of the first Data Channel |
| | | Application required in the Data Channel |
| | | Application list. |
| | | This IE presents if the requested Data |
| | | Channel Application is not the first one in |
| | | the Data Channel Application list, e.g. when |
| | | the Data Channel Application list is needed |
| | | to be shown in multiple pages, this IE is |
| | | needed to be included when request the |
| | | pages other than the first page. |
| | | The default value of this IE is 0 if this IE is |
| | | absent. |
| Number of | O | The total number of Data Channel |
| application | | Application profiles required in this request |
| profile | | |
| required | | |

(NOTE):
The eMMTel service provider can provide the eMMTel Client with different Data Channel Application profile list based on this IE.

The application type IE may indicate the type of application for which the UE is requesting detailed information. The application type may include, but may not be limited to, emergency, conference, extended reality (XR), or any other suitable type of application. The application type IE may have an optional status in the application profile list request.

The application profile list response receiving module 426 may be configured to receive an application profile list response. The application profile list response may include the list of one or more DC applications, a version associated with the one or more DC applications, and a validity associated with the one or more DC applications. The list of one or more DC applications may be based on the second application type IE. The application profile list response receiving module 426 may be implemented on the UE 208.

Table 4 illustrates a list of IEs in the application profile list response.

TABLE 4

| Information | | |
|---|---|---|
| element | Status | Description |
| Data Channel | M | A list of Data Channel Application profiles |
| Application | | available for this user. Each element in this list |
| profile list | | contains a DC application profile of this Data |
| | | Channel Application. |
| | | The detailed information elements of DC |
| | | application profile are listed in Table 8.3.2.1-5. |

The detailed information elements of the DC application profile are listed in Table 5.

TABLE 5

| Information | | |
|---|---|---|
| element | Status | Description |
| Application | M | Identifier of the Data Channel |
| ID | | Application |
| Application | O | Name of the Data Channel Application |
| Name | | |
| Application | O | Icon of the Data Channel Application |
| Icon | | |
| Application | O | The newest version of the application. |
| Version | | |
| Application | O | The latest validity of the application. |
| Validity | | |
| Application | O | Indicates when this Data Channel Application |
| Loading | | is allowed to be used. The values of this IE |
| Phase | | include: |
| | | a) Precall only: the Data Channel Application |
| | | is allowed to be used before the eMMTel call |
| | | session is established, i.e. after the 18x |
| | | response is sent/received and before the 200 |
| | | OK of the initial SIP INVITE request is |
| | | sent/received. |
| | | b) Incall: the Data Channel Application is |
| | | allowed to be used after the eMMTel call |
| | | session is established, i.e. after the 200 OK |
| | | of the initial SIP INVITE request is |
| | | sent/received. |
| Autoload | O | Indicates whether this Data Channel |
| (see NOTE) | | Application is needed to be load to the UE |
| | | automatically. |
| Autolaunch | O | Indicates whether this Data Channel |
| (see NOTE) | | Application is needed to be downloaded to |
| | | the UE and run automatically. |
| If Work | O | Indicates whether this Data Channel |
| Without | | Application can be used if Data Channel is |
| Peer DC | | not supported by the other party of the call. |
| Supported | O | Indicates supported media type required for |
| Scenario | | this Data Channel Application. The values of |
| | | this IE include: |
| | | a) Voice call only: this Data Channel |
| | | Application can be used if and only if the |
| | | corresponding call is a voice call. |
| | | b) Video call only: this Data Channel |
| | | Application can be used if and only if the |
| | | corresponding call is a video call. |
| | | c) Voice and video call: this Data Channel |
| | | Application can be used in both voice call and |
| | | video call. |
| 3gpp Qos Hint | O | Indicates the QoS requirement of this Data |
| | | Channel Application which is used to set the |
| | | value of “a = 3gpp-qos-hint” attribute in SDP |
| | | for the data channel(s) used by the |
| | | application. |

(NOTE):
These IEs can be applied only if the specific service using this data channel application is agreed to be used by the user based on the subscription of this specific service, or explicitly agreed to be applied by the user on the UE.

The Application Version IE may indicate the newest version of the data channel application. The Application Version IE may have an optional status in the DC application profile. The Application Version IE may be used by the UE 208 to determine whether the locally stored DC application needs to be updated.

The Application Validity IE may indicate the latest validity of the data channel application. The Application Validity IE may have an optional status in the DC application profile. The Application Validity IE may be used by the UE 208 to determine whether the locally stored DC application is still valid for use.

The one or more DC applications may be presented to the user for selection. The user may select a DC application from the one or more DC applications.

In an embodiment, the DC application selection module 428 may be configured to enable the selection of a DC application among the list of one or more DC applications. The user may select the DC application from the list of one or more DC applications.

In another embodiment, the correlation determination module 430 may be configured to determine a correlation between one or more of a version and the validity of the selected DC application stored in the UE 208, and one or more of the corresponding application version IE and the corresponding application validity IE in the application profile list response. The correlation determination module 430 may compare a locally stored DC application version and validity with the version and validity received in the application profile list response.

In yet another embodiment, the downloading module 432 may be configured to download the selected DC application. The downloading module 432 may download the selected data channel application when the correlation determination module 430 determines that the version of the selected DC application stored in the UE is older than the corresponding application version IE. The downloading module 432 may also download the selected DC application when the correlation determination module 430 may determine that the validity of the selected DC application stored in the UE 208 is expired.

If the correlation module determines that the version of the selected DC application stored in the UE 208 is the newest version and that the validity of the selected DC application stored in the UE 208 is valid, the UE 208 may load the DC application form the cache rather than downloading it from the server.

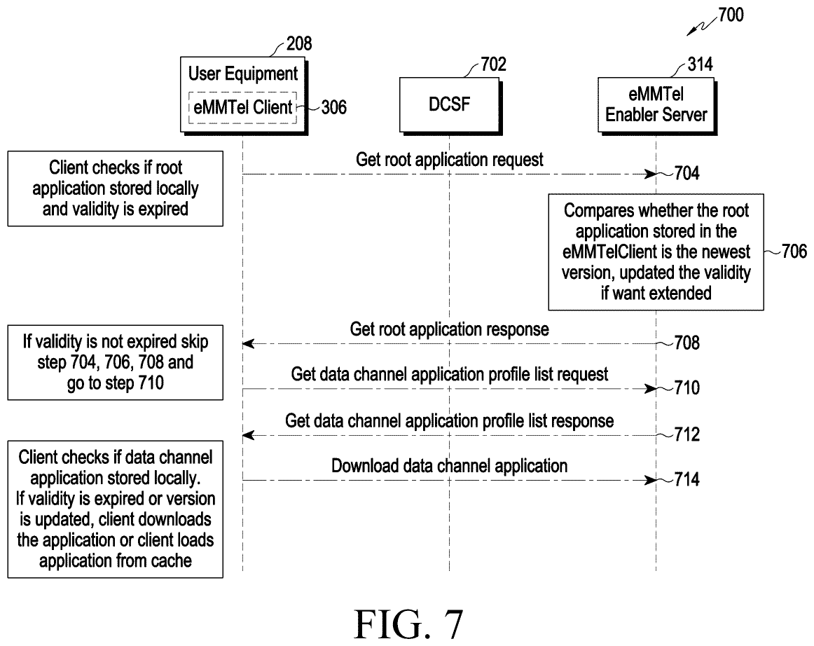

FIG. 7 illustrates a signal flow diagram depicting the method for managing DC communication between the UE 208 and the server 206, according to an embodiment of the disclosure.

The process flow 700 begins with the UE 208 checking if the root application is stored locally and if its validity is expired. The eMMTel Client 306 within the UE 208 performs the validity check before initiating any communication with the server 206.

The process flow 700, at operation 704, involves the UE 208 sending a Get root application request to the eMMTel Enabler Server 314 through the DCSF 702. The Get root application request may be sent when the UE 208 determines that the locally stored root application has expired validity or when no root application is stored locally.

At operation 706, the eMMTel Enabler Server 314 compares whether the root application stored in the eMMTel Client 306 is the newest version. The eMMTel Enabler Server 314 may also update the validity of the root application if an extension is desired. The eMMTel Enabler Server 314 may perform the comparison based on the root application version IE included in the Get root application request.

At operation 708, the eMMTel Enabler Server 314 sends a Get root application response to the UE 208 through the DCSF 702. The Get root application response may include the root application validity IE, the root application version IE, and a list of available data channel applications.

If the validity of the locally stored root application is not expired, the UE 208 may skip operations 704, 706, and 708, and proceed directly to operation 710.

At operation 710, the UE 208 sends a Get data channel application profile list request to the eMMTel Enabler Server 314 through the DCSF 702. The Get data channel application profile list request may include the second application type IE to specify the type of applications for which detailed information is requested.

At operation 712, the eMMTel Enabler Server 314 sends a Get data channel application profile list response to the UE 208 through the DCSF 702. The Get data channel application profile list response may include detailed information about the requested DC applications, including their versions and validity periods.

The UE 208 then checks if the requested DC application is stored locally. If the validity of the locally stored data channel application is expired or if its version is outdated, the UE 208 proceeds to operation 714. If the requested DC application is valid and up-to-date, the UE 208 may load the application from the local cache.

At operation 714, the UE 208 sends a download data channel application request to the eMMTel Enabler Server 314 through the DCSF 702. In response, the eMMTel Enabler Server 314 provides the requested DC application to the UE 208.

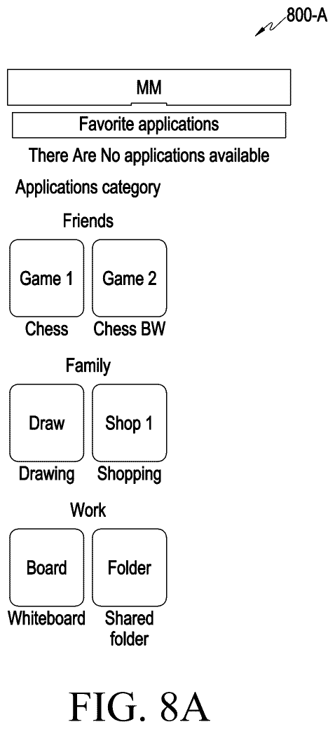

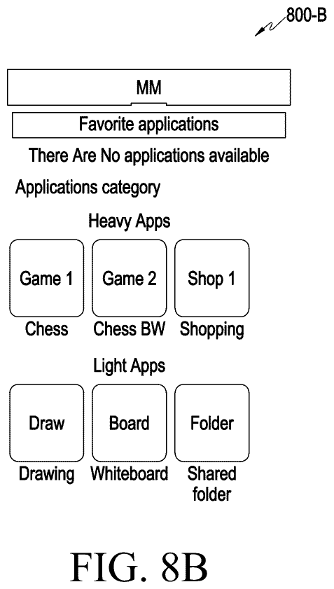

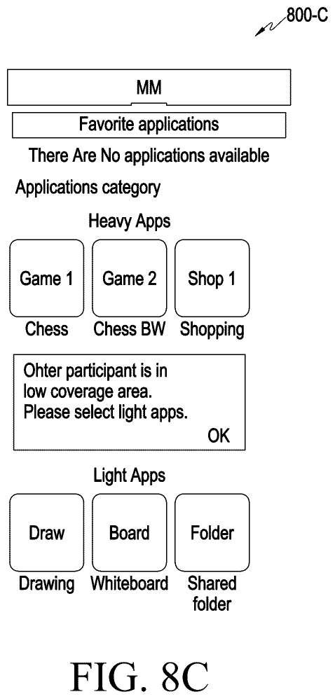

FIGS. 8A to 8C illustrate various use cases of the system and the method for managing DC communication, according to various embodiments of the disclosure.

As shown in the root application interface 800-A, the system may categorize DC applications based on different groups such as Friends, Family, and Work, allowing users to easily locate and access applications relevant to specific contexts. The root application interface 800-B, for example, represents an alternative categorization approach where applications are organized as heavy apps and light apps, enabling users to select applications based on their resource requirements. The root application interface 800-C demonstrates a user experience enhancement feature where a notification is displayed to inform users when the other participant is in a low coverage area, suggesting the selection of light applications to ensure optimal performance during the communication session.

In an embodiment, an IDC application store may have 100 applications and three users, user A, user B, and user C may connect over a call. In the conventional techniques, during the first call between users A and B, two applications (X and Y apps) may be launched, consuming approximately 200 MB of data with an app launch time of 20 seconds. During the second call between users A and C, when two applications (X and Z apps) may be launched, the system consumes 150 MB of data with an app launch time of 15 seconds. For the third call between users A and B, when three applications (X, Y, and Z apps) may be launched, the system consumes 250 MB of data with an app launch time of 25 seconds. The total data consumed across all three calls using the conventional technique is 600 MB, with an unproductive time of 60 seconds.

In contrast, the disclosure shows significant improvements. While the first call requires the same data consumption (200 MB) and launch time (20 seconds), the second call's data consumption is reduced to only 50 MB with a reduced launch time of 5 seconds. Most notably, for the third call, the data consumption drops to OMB with an app launch time of 0 seconds, as the system can reuse previously downloaded applications instead of downloading them again. The total data consumed across all three calls in the proposed method is only 250 MB, with a total unproductive time of just 25 seconds, representing a 58% reduction in data consumption and a 58% improvement in time efficiency compared to the existing approach.

In another example embodiment, for 1 IDC application, the disclosure may save 100 KB of data on the root application and about 100 MB of data on the selected application. Thus, the disclosure may save 100.1 MB on 1 IDC application. Similarly, for 100 IDC applications, the disclosure may save 1000.1 MB of data. The significant reduction in data consumption may enhance user experience by reducing waiting time, conserving mobile data usage, and improving overall system efficiency.

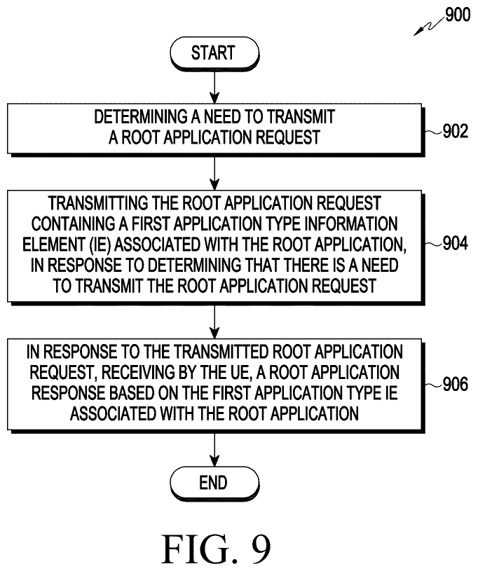

FIG. 9 illustrates a flow chart depicting the method 900 for managing data channel communication, according to an embodiment of the disclosure.

The method 900 may be a computer-implemented method executed by the UE 208 and the modules of the system. For the sake of brevity, constructional and operational features of the system that are already explained in the description of preceding figures are not explained in detail in the description of FIG. 9.

The method 900, at operation 902, involves determining, by the UE, the need to transmit the root application request. Thereafter, at operation 904, the method 900 involves transmitting, by the UE 208, the root application request containing the first application type IE associated with the root application, in response to determining that there is the need to transmit the root application request. Subsequently, at operation 906, the method 900 involves receiving, by the UE, the root application response based on the first application type IE associated with the root application, in response to the root application request being transmitted.

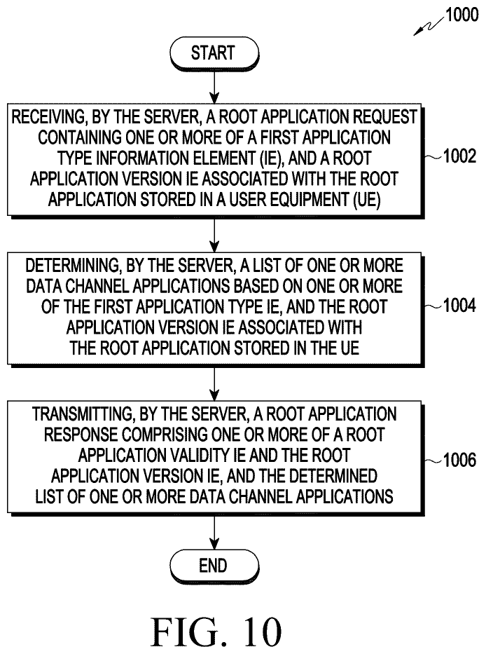

FIG. 10 illustrates a flow chart depicting the method 1000 for managing data channel communication, according to another embodiment of the disclosure.

The method 1000 may be a computer-implemented method executed by the server 206 and the modules of the system 400. For the sake of brevity, constructional and operational features of the system 400 that are already explained in the description of preceding figures are not explained in detail in the description of FIG. 10.

The method 1000, at operation 1002, involves receiving, by the server, the root application request containing one or more of the first application type IE, and the root application version IE associated with the root application stored in the UE 208. Thereafter, at operation 1004, the method 1000 involves determining, by the server, the list of one or more data channel applications based on one or more of the first application type IE, and the root application version IE associated with the root application stored in the UE 208. Subsequently, at operation 1006, the method 1000 involves transmitting, by the server, the root application response comprising one or more of the root application validity IE and the root application version IE, and the determined list of one or more data channel applications.

At least by virtue of the aforesaid, the subject matter at least provides the following advantages:
The disclosure herein provides faster application launch time by enabling re-use of stored root and data channel applications when their validity has not expired and there is no change in application versions, thereby significantly reducing wait time, and enhancing user experience.

The disclosure herein conserves background data usage by avoiding unnecessary downloads of root and data channel applications during bootstrap procedures when valid applications are already stored locally on the UE, resulting in up to 58% reduction in data consumption across multiple communication sessions.

The disclosure herein reduces network load by optimizing the bootstrap procedure, eliminating redundant transmissions of application data, and enabling efficient utilization of network resources during data channel communication.

The disclosure herein presents the most relevant applications to users based on various factors, including contact groups, Radio Access Technology (RAT), and connectivity status of other participants, enhancing the relevance and usefulness of available applications during communication sessions.

The disclosure herein provides critical advantages during emergency calls by prioritizing and efficiently loading emergency-related applications, ensuring rapid access to essential features during time-sensitive situations.

The disclosure herein offers business advantages by enabling targeted presentation of business-related applications when calls are made to business numbers, creating opportunities for contextual application discovery and specialized service delivery in professional communication contexts.

While specific language has been used to describe the disclosure, any limitations arising on account of the same are not intended. As would be apparent to a person in the art, various working modifications may be made to the method in order to implement the inventive concept as taught herein.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device individually or collectively, cause the electronic device to perform a method of the disclosure.

Any such software may be stored in the form of volatile or non-volatile storage such as, for example, a storage device like read only memory (ROM), whether erasable or rewritable or not, or in the form of memory such as, for example, random access memory (RAM), memory chips, device or integrated circuits or on an optically or magnetically readable medium such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method as claimed in any one of the claims of this specification and a non-transitory machine-readable storage storing such a program.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A method for managing data channel communication by a user equipment (UE), the method comprising:
determining to transmit a root application request;
transmitting, to a server, the root application request comprising a first application type information element (IE) associated with a root application, based on determining to transmit the root application request; and
receiving, from the server, a root application response based on the first application type IE associated with the root application, in response to the root application request,
wherein the root application response comprises:
a list of data channel applications,
a root application version IE, and
a root application validity IE.

2. The method of claim 1, wherein determining to transmit the root application request comprises:
identifying a validity status of a locally stored root application, and
determining to transmit the root application request in response to determining that the validity status of the locally stored root application is expired.

3. The method of claim 1, further comprising:
in response to receiving the root application response, transmitting a data channel application profile list request comprising at least a second application type IE; and
in response to transmitting the data channel application profile list request, receiving an application profile list response comprising a list of one or more data channel applications, a version associated with the one or more data channel applications, and a validity associated with the one or more data channel applications, based on at least the second application type IE.

4. The method of claim 3, further comprising:
in response to receiving the application profile list response:
identifying a user selection of a data channel application among the list of one or more data channel applications;
determining a correlation between one or more of a version and a validity of the selected data channel application stored in the UE, and one or more of the corresponding application version IE and the corresponding application validity IE in the application profile list response; and
downloading the selected data channel application, in response to at least one of:
a correlation that the version of the selected data channel application stored in the UE is older than the corresponding application version IE, and
a correlation that the validity of the selected data channel application stored in the UE is expired.

5. The method of claim 1, further comprising:
in response to receiving the root application response, updating, based on one or more of the root application validity IE and the root application version IE, a locally stored root application.

6. The method of claim 1, wherein the root application acts as a container for data channel applications during a communication session.

7. The method of claim 1, wherein the root application version IE indicates a current version of the root application available on the server.

8. A method for managing data channel communication by a server, further comprising:
receiving, from a user equipment (UE) a root application request comprising a first application type information element (IE) associated with a root application stored in the UE;
determining a list of one or more data channel applications based on one or more of the first application type IE associated with the root application stored in the UE; and
transmitting, to the UE, a root application response comprising a root application validity IE and a root application version IE, and the determined list of one or more data channel applications.

9. The method of claim 8, wherein determining the list of one or more data channel applications comprises:
correlating the root application version IE associated with the root application stored in the UE with a version of a root application stored on the server; and
determining the list of one or more data channel applications based on the first application type IE, in response to the correlation that the root application version IE associated with a root application stored in the UE is older than the version of the root application stored on the server.

10. The method of claim 9, further comprising:
after determining the list of one or more data channel applications, transmitting a root application comprising the determined list of one or more data channel applications.

11. The method of claim 8, wherein the root application acts as a container for data channel applications during a communication session.

12. The method of claim 8, wherein the root application version IE indicates a current version of the root application available on the server.

13. A user equipment for managing data channel communication, the UE comprising:
memory, comprising one or more storage media, storing instructions; and
at least one processor communicatively coupled to the memory,
wherein the instructions, when executed by the at least one processor individually or collectively, cause the UE to:
determine to transmit a root application request,
transmit, to a server, the root application request comprising a first application type information element (IE) associated with a root application, based on determining to transmit the root application request, and
receive, from the server, a root application response based on the first application type IE associated with the root application, in response to the root application request, and
wherein the root application response comprises:
a list of data channel applications,
a root application version IE, and
a root application validity IE.

14. The UE of claim 13, wherein, to determine the need to transmit the root application request, the instructions that, when executed by the at least one processor individually or collectively, cause the UE to:
identify a validity status of a locally stored root application; and
determine to transmit the root application request in response to determining that the validity status of the locally stored root application is expired.

15. The UE of claim 13,
in response to receiving the root application response, the instructions that, when executed by the at least one processor individually or collectively, further cause the UE to transmit a data channel application profile list request comprising at least a second application type IE; and
in response to transmitting the data channel application profile list request, the instructions that, when executed by the at least one processor individually or collectively, further cause the UE to receive an application profile list response comprising a list of one or more data channel applications, a version associated with the one or more data channel applications, and a validity associated with the one or more data channel applications, based on at least the second application type IE.

16. The UE of claim 15, wherein, in response to receiving the application profile list response, the instructions that, when executed by the at least one processor individually or collectively, further cause UE to:
identify a user selection of a data channel application among the list of one or more data channel applications,
determine a correlation between one or more of a version and a validity of the selected data channel application stored in the UE, and one or more of the corresponding application version IE and the corresponding application validity IE in the application profile list response, and
download, the selected data channel application, in response to at least one of:
a correlation that the version of the selected data channel application stored in the UE is older than the corresponding application version IE, and
a correlation that the validity of the selected data channel application stored in the UE is expired.

17. The UE of claim 13, wherein, in response to receiving the root application response, the instructions that, when executed by the at least one processor individually or collectively, further cause the UE to update, based on one or more of the root application validity IE and the root application version IE, a locally stored root application.

18. The UE of claim 13, wherein the root application acts as a container for data channel applications during a communication session.

19. The UE of claim 13, wherein the root application version IE indicates a current version of the root application available on the server.
